(19) United States
(12) Patent Application Publication
(10) Pub. No.: US 2008/0259204 A1
(43) Pub. Date: Oct. 23, 2008

(54) Digital Image Acquisition Vision Sensor

(76) Inventors: Vildo Luperini, Genova (IT); Mario Marson, Genova (IT)

Correspondence Address: BERENATO, WHITE & STAVISH, LLC, 6550 ROCK SPRING DRIVE, SUITE 240, BETHESDA, MD, 20817, US

(21) Appl. No.: 12/088,115

(22) PCT Filed: Sep. 28, 2006
(86) PCT No.: PCT/EP2006/066862

§ 371 Date: Jun. 30, 2008

(30) Foreign Application Priority Data
Sep. 29, 2005 (IT) TO2005A 000681

(51) Int. Cl. H04N 5/222

(52) U.S. Cl. 348/370; 348/E05.022

(57) ABSTRACT

A digital image acquisition vision sensor, wherein a television camera defines a pickup axis, and a lighting device associated with the television camera has a Fresnel lens connected to the television camera so that the television camera is integrated with the lighting device, and the energy released by the lighting device is substantially coaxial with the pickup axis.

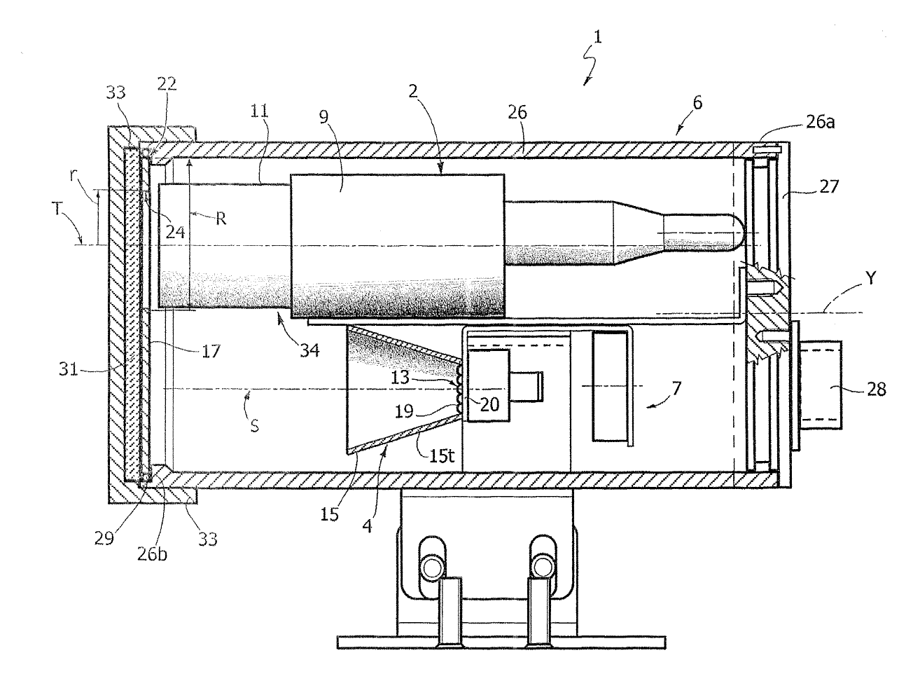

### TECHNICAL FIELD

The present invention relates to a digital image acquisition vision sensor.

### BACKGROUND ART

Vision sensors are known which constitute the sensing element of artificial vision systems used for various purposes, such as picking up license plates, artificial reading, video-monitoring and security systems, etc.

Vision sensors normally comprise a television camera; and a lighting device associated with the television camera to illuminate an area in space covered by the television camera.

The lighting device normally comprises discrete LEDs or filtered halogen lamps.

Known lighting devices have a number of drawbacks, including:
normally poor efficiency;
normally considerable size.

### DISCLOSURE OF INVENTION

It is an object of the present invention to provide a highly efficient vision sensor which provides for effectively illuminating the area in space covered by the television camera.

According to the present invention, there is provided a sensor as described in Claim 1.

### BRIEF DESCRIPTION OF THE DRAWING

The invention will now be described with particular reference to the attached drawing showing a sensor in accordance with the teachings of the present invention.

### BEST MODE FOR CARRYING OUT THE INVENTION

Number 1 in the accompanying drawing indicates as a whole a vision sensor for acquisition of a digital image.

Sensor 1 comprises a commercial (in particular, monochromatic) television camera 2; and a high-intensity lighting device 4 integrated in television camera 2.

Sensor 1 also comprises a protective casing 6 housing television camera 2, high-intensity lighting device 4, and the electronic circuits 7 (shown schematically) controlling operation of high-intensity lighting device 4 and television camera 2.

The power supply (not shown) of sensor 1 may be located either outside (as shown) or inside sensor 1.

In the example embodiment shown, television camera 2 has a cylindrical body 9, and a standard (e.g. 25 mm) cylindrical objective 11 coaxial with a pickup axis T. It is understood, however, that television camera 2 may be of any form, and comprise objectives other than the one shown.

High-intensity lighting device 4 is located to one side of cylindrical body 9 of television camera 2, and comprises a light source 13 operating in the infrared range; a substantially truncated-cone-shaped reflecting device 15 fitted to light source 13 and having an axis S parallel to axis T of television camera 2; and a Fresnel lens 17 facing reflecting device 15 and objective 11.

As is known, a Fresnel lens is a planoconvex lens having a number of stepped concentric rings in the form of convex surface sections, for achieving the same curvature of the light rays as a much thicker normal lens.

Reflecting device 15 is conveniently formed by depositing metal (e.g. silver or gold) on the inner surface of a truncated-cone-, cup-shaped member 15t.

More specifically, light source 13 is defined by a matrix (e.g. square or round matrix) of LEDs 19 operating in the infrared range and fitted to a flat base 20 (e.g. a printed circuit) perpendicular to axis S.

LEDs 19 are arranged adjacent to one another to form, as a whole, a plane light source 13 located adjacent to a first end of cup-shaped member 15t.

In the example embodiment shown, Fresnel lens 17 has a flat circular perimeter, is perpendicular to axes T and S, and has an axis coincident with axis S of light source 13.

More specifically, circular Fresnel lens 17 has a radius R; a free circular edge 22 extending beyond the intersections of axes T and S and lens 17; and a circular through opening 24 facing objective 11, coaxial with axis T, and having a radius r, where r<R.

Radius r of opening 24 depends on, and is a few millimetres smaller than, the outside radius of the objective 11 used.

Casing 6 comprises a cylindrical tubular body 26 having an axis Y parallel to axes T and S, and comprising a first end portion 26a closed by a wall 27 crosswise to axis Y. Wall 27 is conveniently fitted with a number of electric connectors 28 communicating with electronic circuits 7.

Cylindrical tubular body 26 has a second end portion 26b closed by Fresnel lens 17, the free edge 22 of which rests on an edge of tubular body 26 with the interposition of a retaining ring (O-ring) 29.

An infrared filter 31 is positioned facing Fresnel lens 17, on the opposite side to light source 13, and is fitted to an annular ring nut 33 screwed to tubular body 26.

In actual use, when LEDs 19 are powered, some of the rays emitted by light source 13 reach Fresnel lens 17 directly, and some are directed onto Fresnel lens 17 by reflecting device 15.

Plane light source 13 in fact emits in a solid angle much larger than that subtended by Fresnel lens 17 (with respect to light source 13).

Truncated-cone-shaped reflecting device 15 recovers the otherwise lost rays emitted by source 13, and reflects them back close to the source, thus increasing its virtual dimension (source plus reflected image), but, above all, increasing the flow of energy to the lens.

Plane light source 13 has only one point at the focus of reflecting device 15, so that, for known optical reasons, the rays impinge on the Fresnel lens at different angles of incidence. Fresnel lens 17 provides for “straightening” the incident beam, so that the rays exiting lens 17 travel substantially parallel to axis S and therefore to axis T of the television camera.

Television camera 2 is thus integrated with lighting device 4, and the energy released by lighting device 4 is substantially coaxial with pickup axis T. Axes T and S in fact are a very small distance, typically 35 mm, apart, but the infrared rays closest to pickup axis T are at a distance of no more than 15 mm.

The pickup axis T of the television camera is thus brought closer to the flow of infrared energy emitted by the lighting device.

Television camera 2 can also “see” through opening 24 coaxial with axis T and facing objective 11, i.e. the light rays from the scene being viewed travel through opening 24 in the Fresnel lens to the sensitive element of television camera 2.

Plane light source 13 (i.e. the LED matrix) has an area A much smaller than the area A_{F} defined by the perimeter of Fresnel lens 17. The efficiency of lighting device 4 in fact increases as a function of the ratio A_{F}/A_{L}, where A_{L} is the active area of the lighting device (i.e. the area including the area of plane light source 13 and the area of the reflected image).

Vision sensor 1 may also comprise an adjusting device 34 for adjusting the distance (measured along axis S) between Fresnel lens 17 and lighting device 4.

Adjusting device 34 may, for example, permit reversible linear movement of light source 13 and reflecting device 15 with respect to Fresnel lens 17, which remains fixed.

The distance between Fresnel lens 17 and the active area of the lighting device (plane light source 13 plus the reflected image) defines the output angle of the energy flow.

Increasing the distance between Fresnel lens 17 and the active area reduces the output angle of the beam (“collimated” beam), and reducing the distance between Fresnel lens 17 and the active area increases the output angle of the beam.

In this connection, it should be pointed out that, in known devices using LEDs, the emission angle of the lighting device depends on the type of LED used, and can therefore only be modified using a different type of LED.

In a preferred embodiment, filter 31 is a high-pass type, television camera 2 also has an internal low-pass filter (not shown), and the two filters combine to form a band-pass filter centred at the frequency of the radiation emitted by lighting device 4.

The device according to the present invention has a number of advantages, including:
maximum coupling of pickup axis T of television camera 2 and the energy flow from the lighting device;
the vision sensor itself is extremely compact, for minimum visual impact;
adjustment (by adjusting device 34) of the energy emission angle of the lighting device; and
the possibility of providing (inside casing 6) two or four lighting devices and corresponding Fresnel lenses for improved performance over very long distances (more than 30 m).

1) A vision sensor comprising:
a television camera (2) defining a pickup axis (T); and
at least one lighting device (4) associated with the television camera;
characterized in that the lighting device (4) comprises a Fresnel tens (17) coupled with the television camera so that the television camera is integrated with said lighting device, and the energy released by said lighting device is substantially coaxial with the pickup axis (T)
said Fresnel lens has at least one through opening (24) substantially coaxial with said pickup axis (T) and adjacent to an objective (11) of the television camera (2).

2) A sensor as claimed in claim 1, wherein said lighting device (4) comprises a plane light source.

3) A sensor as claimed in claim 2, wherein said plane light source is defined by a matrix of LEDs.

4) A sensor as claimed in claim 2, wherein said plane light source (13) has an area (A) much smaller than the area (AF) defined by the perimeter of the Fresnel lens (17).

5) A sensor as claimed in claim 2, wherein said lighting device (4) also comprises a reflecting device (15) interposed between said plane light source and said Fresnel lens.

6) A sensor as claimed in claim 5, wherein said reflecting device (15) comprises a truncated-cone-shaped reflecting surface having a first free end facing said plane light source, and a second free end facing said Fresnel lens (17).

7) (canceled)

8) A sensor as claimed in claim 2, wherein said Fresnel lens (17) has an axis coincident with the axis
(S) of the light source.

9) A sensor as claimed in claim 1, wherein adjusting means (34) are provided to adjust the distance between the Fresnel lens (17) and the lighting device (4).

10) A sensor as claimed in claim 1, wherein a first external filter (31) is provided facing said Fresnel lens (17); said television camera (2) having a second internal filter, and the two filters combining to form a pass-band filter centred at the frequency of the radiation emitted by the lighting device (4).
